(19) United States
(12) Patent Application Publication
(10) Pub. No.: US 2008/0000381 A1
(43) Pub. Date: Jan. 3, 2008

(54) RAIL CAR BRAKING REGENERATION AND PROPULSION SYSTEM AND METHOD

(76) Inventors: Thomas Lee Bartley, San Diego, CA (US); Paul Everett Kaufman, Bernardsville, NJ (US)

Correspondence Address: PROCOPIO, CORY, HARGREAVES & SAVITCH LLP, 530 B STREET, SUITE 2100, SAN DIEGO, CA, 92101, US

(21) Appl. No.: 11/420,064

(22) Filed: May 24, 2006

(51) Int. Cl. B61C 3/00; B60T 8/64; G05D 3/12

(52) U.S. Cl. 105/49; 303/152; 701/20

(57) ABSTRACT

A braking regeneration and propulsion system for a passive rail car including an axle with wheels includes a gear box to be operatively coupled to the axle; a motor/generator operatively coupled to the gear box; an energy storage for storing captured energy and supplying energy; and a control computer to assist deceleration of the passive rail car by causing the axle to drive the motor/generator via the gear box and supply energy to the energy storage system during deceleration, and, assist acceleration of the passive rail car by causing the motor/generator to draw energy from the energy storage system and drive the wheels via the gear box and axle during acceleration.

### FIELD OF THE INVENTION

The field of the invention relates to braking energy regeneration systems and methods that capture and recycle wasted energy in passive rail cars.

### SUMMARY OF THE INVENTION

It has been estimated that a 125,000 pound Comet V commuter rail car traveling at 70 mph dissipates about 7.8 kWh of kinetic energy as heat and brake wear every time the rail car is slowed to a stop.

The present invention involves an axle-mounted braking regeneration system and method that allows the capture and recycling of this wasted energy. The braking regeneration system and method of the present invention is applicable to commuter rail cars, including trailer and cab configurations, and other passive rail cars such as flat cars, tank cars, bulk material cars, box cars, fuel cars, specialty cars, cabooses, and any other passive rail cars that are not considered to be a locomotive.

Another aspect of the invention involves a braking regeneration and propulsion system for a passive rail car including an axle with wheels, the passive rail car primarily propelled by a separate pulling or pushing locomotive. The braking regeneration and propulsion system includes a gear box to be operatively coupled to the axle; a motor/generator operatively coupled to the gear box; an energy storage system for storing captured energy and supplying energy; and a power switching device to manage the energy flow that is controlled by a control computer to assist deceleration of the passive rail car by causing the axle to drive the motor/generator via the gear box and supply energy to the energy storage system during deceleration, and, assist acceleration of the passive rail car by causing the motor/generator to draw energy from the energy storage system and drive the wheels via the gear box and axle during acceleration. In an alternative aspect of the invention, a gear box operatively coupled to the axle and a motor/generator operatively coupled to the gear box, may be replaced by a motor/generator that is operatively coupled to the axle, is part of the axle, or is part of one or more of the wheels attached to the axle.

Another aspect of the invention involves a method of using a braking regeneration and propulsion system with a passive rail car including an axle with wheels, the passive rail car primarily propelled by a separate pulling or pushing locomotive. The method includes providing a braking regeneration and propulsion system including: a gear box to be operatively coupled to the axle; a motor/generator operatively coupled to the gear box; an energy storage system for storing captured energy and supplying energy; and a power switching device to manage the energy flow that is controlled by a control computer to assist deceleration of the passive rail car by causing the axle to drive the motor/generator via the gear box and supply energy to the energy storage system, and assist acceleration of the passive rail car by causing the motor/generator to draw energy from the energy storage system and drive the wheels via the gear box and axle; assisting deceleration of the passive rail car by causing the axle to drive the motor/generator via the gear box and supply energy to the energy storage system; and assisting acceleration of the passive rail car by causing the motor/generator to draw energy from the energy storage system and drive the wheels via the gear box and axle. In an alternative aspect of the invention, a gear box operatively coupled to the axle and a motor/generator operatively coupled to the gear box, may be replaced by a motor/generator that is operatively coupled to the axle, is part of the axle, or is part of one or more of the wheels attached to the axle.

A typical rail car may rest on multiple axles or on multiple truck supports with multiple axles. Thus this invention may be replicated in part or in whole for each rail car or truck supporting axle.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a block diagram depicting an embodiment of an axle-mounted braking regeneration system for a passive rail car.

FIG. 2 is a block diagram depicting an embodiment of the axle-mounted braking regeneration system on a multi-axle passive rail car.

FIG. 3 is a graph of speed versus time for a diesel consist with a braking regeneration, energy storage, and acceleration system that runs at a continuous power level of 300 kW and consumes 8.4 kWh of energy, and a diesel consist without a braking regeneration energy storage and acceleration system.

FIG. 4 is another graph of speed versus time for a diesel consist with a braking regeneration, energy storage, and acceleration system that runs at a continuous power level of 133 kW and consumes 4.8 kWh of energy, and a diesel consist without a braking regeneration energy storage and acceleration system.

FIG. 5 is a block diagram illustrating an exemplary computer system that may be used in connection with the various embodiments described herein.

### DETAILED DESCRIPTION OF A PREFERRED EMBODIMENT

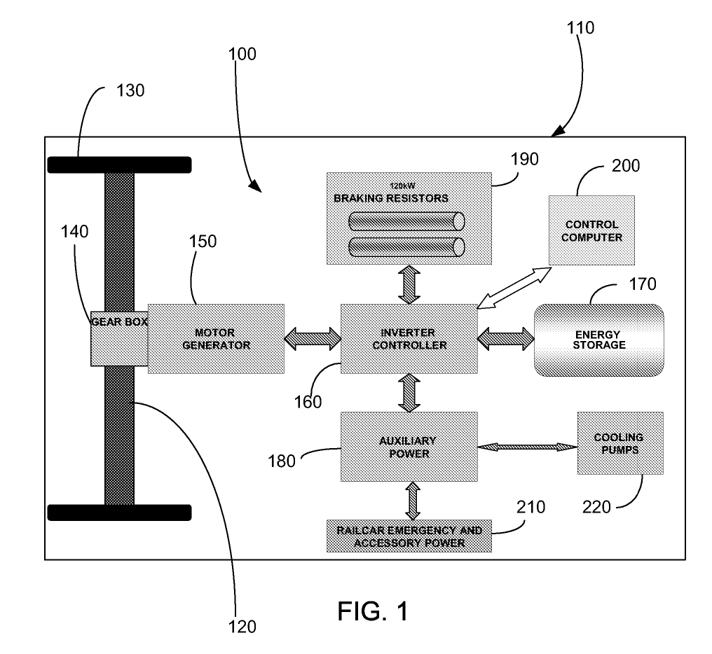

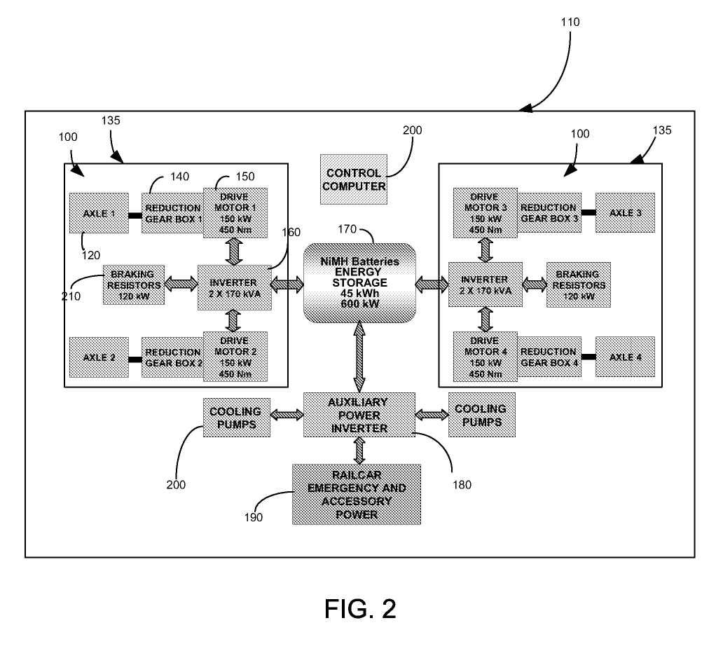

With reference to FIGS. 1 and 2, an axle-mounted braking regeneration energy storage and acceleration system 100 for a passive rail car 110 will be described. As used herein, “passive rail car” refers to rail car primarily propelled (e.g., pulled, pushed) by a separate driving rail car (e.g., locomotive). A passive rail car has no primary power unit for the conversion of chemical fuel into electric or kinetic energy used to propel the vehicle. A rail car is defined as a flange wheeled vehicle where the wheels roll on and are guided by rails on a road bed also known as a railroad track. Although the braking regeneration system 100 will be described as being axle-mounted, in alternative embodiments, the braking regeneration system 100 is mounted to other and/or additional structures of a passive rail car.

In the embodiment shown, the passive rail car 110 is a Comet V commuter rail car including multiple axles 120 with wheels 130 on opposite ends of the axles 120 and a friction braking system attached to multiple axles. The axles 120 rotate with rotation of the wheels 120. In the embodiment shown in FIG. 2, each rail car includes two trucks 135. Each truck 135 carries two axles 120. The drive and braking regeneration system 100 is repeated for each rail car truck 135. Although the braking regeneration system 100 will be described as being used with a commuter rail car, in alternative embodiments, the braking regeneration system 100 is applied to other passive rail cars other than a commuter rail car such as, but not by way of limitation, flat car, tank car, box car, bulk material car, fuel car, container car, and caboose. Further, although the braking regeneration system 100 will be described at times as being used with a single passive individual rail car 110, in alternative embodiments, the axle-mounted braking regeneration system 100 is applied to an entire train of (or linked series of) passive rail cars often referred to as a “consist”.

The braking regeneration system 100 may include a gear box 140 and a motor/generator 150 for each axle 120, a single dual-inverter/controller 160 per truck 135 (per two axles 120), a single energy storage 170 per rail car 110, a single auxiliary power inverter 180 per rail car, a single set of braking resistors 190 per truck, and a single control computer 200 per rail car 110. In alternative embodiments, one or more of the number of trucks, axles, passive rail cars, braking regeneration systems, components of the braking regeneration system, and/or other elements described herein may vary from that shown and described herein. For example, but not by way of limitation, in an alternative embodiment, the braking regeneration system 100 includes one larger generator/motor incorporated on one axle 120 per rail car 110 instead of four smaller gearbox/motor/generator systems, one on each axle 120 of the rail car 110.

The gear box 140 is mechanically connected to the axle 120. The gear box 140 transfers torque between the axle 120 and the motor/generator 150. At the same time as the gear box 140 provides a speed reduction to match the motor rpm to the axle shaft rpm, the torque increases by the same ratio as the speed reduction. In another alternative embodiment any required rpm speed reduction occurs in the motor connection to the axle 120 and a separate gear box 140 is not required. In yet other alternative embodiments the gear box 140 may include a clutch, multiple gears and a transmission. The single dual-inverter 160 controls both axle drive motor/generators 150 on the truck 135 and performs the power flow switching for the operation of the energy storage 170 and the braking resistors 210. The motor/generator 150 along with the dual-inverter 160 can be Siemens ELFA components that are used on electric and hybrid-electric heavy-duty vehicles. The motor/generator 150 generates energy during braking regeneration and powers the wheels 130 via the gear box 140 and axle 120 during an acceleration mode. In the embodiment shown, the motor/generator 150 is a combined, integrated motor and generator; however, in an alternative embodiment, motor/generator 150 includes physically separated motor and generator. The energy storage 170 includes a central energy storage system, which provides the energy storage for the energy needs of the whole rail car 110. In alternative embodiments, one or more other types of energy storage systems are used such as, but not limited to, one or more or a combination of different battery chemistries, ultracapacitors, flywheels, or springs. A single inverter and power conditioning module 180 provides for the power needs 210 (e.g., rail car emergency power, rail car accessory power, cooling pumps 220) on the rail car 110. A typical commuter rail car accessory power may include lighting, heating, ventilation, air conditioning (HVAC), and plug-in power for electronic devices. The inverter and power conditioning module 180 may replace all or part of the power normally supplied by the head-end power (HEP) from the train locomotive.

The motor/generator 150, the dual-inverter 100, the energy storage 170, the auxiliary power inverter 180, and the braking resistors 110 may be liquid cooled. The liquid cooling loop, not shown, consists of liquid coolant, typically 50/50 water/ethylene glycol, a heat exchanger radiator with electric fans, and coolant pumps 200 to circulate the coolant. One or more coolant loops may be used on the rail car to manage the temperature of the electric power components 150, 160, the energy storage 170, the power conditioning module 180, and the HVAC system.

One of the cooling loops may include the braking resistors 190 that may serve two different functions. The braking resistors 190 are high power electrical resistors that dissipate power by heating a circulating fluid. The coolant heat may be dissipated in one or more of a heat exchanging radiator that radiates heat to the air passing through the heat exchanger, a heat exchanging radiator to heat passenger compartment air, a coolant loop through the energy storage to warm the energy storage 170, and any other component on the rail car that would benefit from receiving additional heat from the coolant or heated air from a heat exchanger. When the motor/generator 150 is generating more power than can be stored in the energy storage 170 and used by the auxiliary power 180, the inverter controller 160 can switch the excess power to the braking resistors to heat the circulating coolant. This may occur when the braking regeneration electromagnetic braking is used rather than add wear to the normal friction brakes. The braking resistors 190 may also be heated by the energy storage 170 and used to supply heat via the circulating fluid to a heat exchanger radiator for heating the passenger compartment of the commuter rail car.

The control computer 200 controls operation of the braking regeneration system 100 in the manner described herein. The braking regeneration systems 100 are controlled by the control computer 200 to initiate the acceleration and deceleration modes without lurching the rail cars 100 and compressing the couplers. Real time onboard sensors along with train communications provide input that is processed by processor(s) of the control computer 200 using the computer control algorithms related to applying power or drag to the consist.

The braking regeneration system 100 will now be described during deceleration and acceleration of the consist.

On deceleration, the generator 150 puts a drag on the axle 120 to slow down the rail car 110. System controls prevent the rail cars 110 from abruptly compressing and extending the couplers. The individual rail cars 110 have their systems activated in an in-line or series configuration, one at a time, to prevent lurching. The independent control system may be transparent to the remainder of the consist or may operate as an integrated control system with other cars of the consist. Below a minimum speed, for example 3 mph, the braking regeneration system is turned off and the standard friction brake system is applied to stop the train.

The energy captured from deceleration would, in turn, be fed through the inverter/controllers 160 and into the nickel metal hydride (NiMH) battery energy storage system 170. The charge and discharge levels of the nickel metal hydride (NiMH) battery energy storage system 170 may be limited to extend the cycle life of the energy storage system 170. Ultracapacitors lack sufficient energy storage for this application. However, in an embodiment of the invention, an ultracapacitor pack is incorporated with the battery pack to protect and extend the life of the battery pack.

On acceleration, the recycled stored energy is consumed as the motor/generators 150 are then configured as electric motors 150 to help the locomotive accelerate the consist. The electric motor/generators 150 operate at least 60 seconds at a 282 kW power level before exhausting the scheduled amount of stored energy. A lower power level for a longer period of time during acceleration puts less stress on the components resulting in lower maintenance costs, increased system life, and improved reliability. The energy management system is designed to have infinite variability of control parameters to provide for optimization of the energy capture and recycle. The power is applied until the approximate 4.7 kWh (on average for this embodiment) are delivered for acceleration.

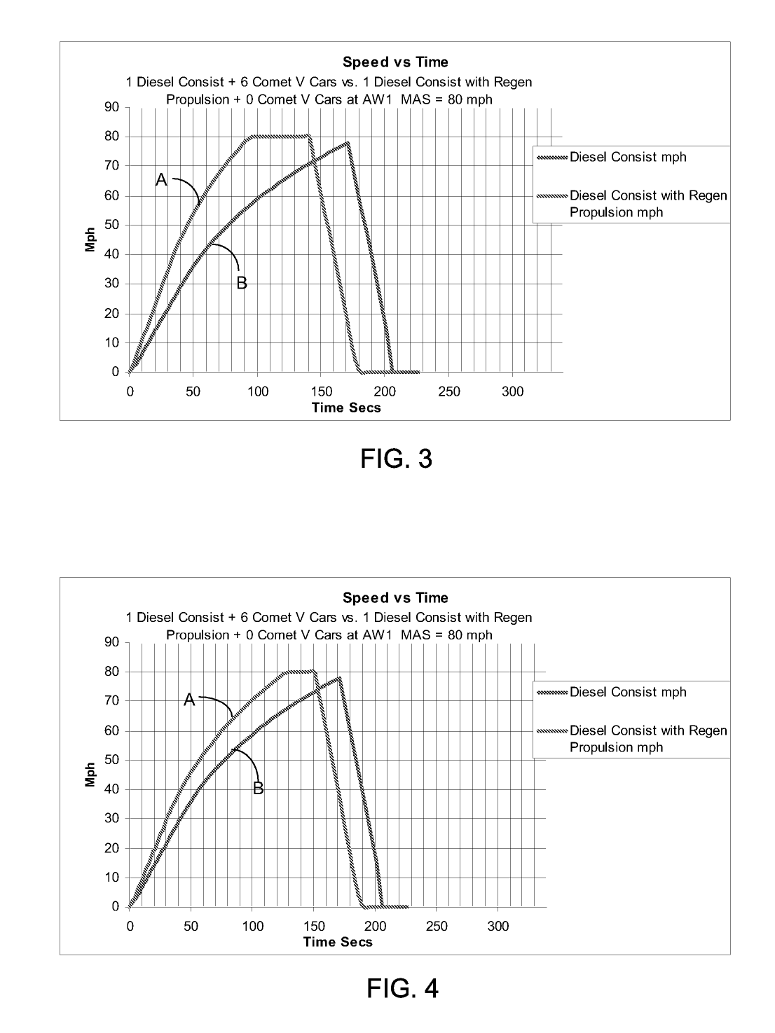

The performance curves in FIGS. 3 and 4 show the acceleration improvement that can be obtained by using the recycled braking regeneration energy from each rail car 110 to assist the diesel locomotive. Higher top speeds can be achieved and, thus, regenerate more braking energy.

The performance is provided by a simulation of a PL42 diesel locomotive with a six car Comet V consist. It is based on test track performance for a 0% grade. The 0% grade assumption is representative of an elevation energy neutral model for two way travel over the route.

FIG. 3 graphically shows the acceleration and braking performance for an average 2.6 mile distance between stations. The acceleration curve A for the braking regeneration system 100 is calculated at a continuous power level of 300 kW. As shown by the curves A, B, a diesel consist with the braking regeneration system 100 accelerates faster and has a greater average speed than a diesel consist without the braking regeneration system 100. The performance curve A for the diesel consist with braking regeneration propulsion shows that the consist can achieve 60 mph in 60 seconds time and can reach maximum track speed inside of 100 seconds. The standard diesel consist (curve B) requires 105 seconds to reach 60 mph and cannot reach maximum track speed in 2.6 miles. This benefit is created by having the braking regeneration system 100 powering a total of 24 driven axles along with the locomotive versus four for just the locomotive. However, this performance uses 8.4 kWh of energy, more than is available from the average recycled braking regeneration. In the embodiment shown, the braking regeneration system 100 assists the rail car 110 in acceleration, but does not provide all required power to accelerate the rail car 110 to top speed. In an alternative embodiment, the braking regeneration system 100 provides all required power to accelerate the rail car 110 (or passive rail car) to top speed.

The graph shown in FIG. 4 is for a more efficient and practical configuration that consumes 4.8 kWh, the same amount of energy as is available from the average recycled braking regeneration event. In this example, the consist can achieve 60 mph in 75 seconds while operating at a continuous power level of 133 kW. This remains a very impressive acceleration curve for a diesel hauled 6-car consist that can achieve a maximum track speed of 80 mph in 130 seconds in a 2.6 mile average distance between stations.

These two graphs demonstrate the unique benefit of the braking regeneration system 100 and the almost infinite flexibility available to optimize energy capture. The backup emergency energy remains available at all times in spite of the energy consumed by acceleration. In addition, the anticipated battery life, due to a reduction in system stress, is increased.

One of the advantages of the braking regeneration system 100 is that it allows the elimination of the emergency power battery system on the rail car along with the battery charger. The braking regeneration system 100 is located under floor, so eliminating the existing emergency power battery system frees up space for the components of the braking regeneration system 100, which may be retrofitted onto existing commuter rail cars 110 (and/or passive rail cars) and/or implemented into the original manufacture of the rail car (and/or passive rail cars) and/or rail car chassis/trucks. The energy storage 170 is managed to guarantee at least two hours of emergency backup energy at any time to comply with the Federal Railway Administration (FRA) regulations. This is done by establishing a depletion point of the energy storage system 170 at a level that insures that the energy storage system 170 will always be able to operate. Present rail cars are marginal or non compliant for providing two hours of emergency backup power when the rail car is just going into revenue service after sitting for a day. The capacity of the energy storage system 170 eliminates any concern about meeting the emergency backup power requirement.

With the amount of onboard energy storage, the braking regeneration system 100 will start up automatically from an overnight layover. Should the energy drop to a minimum threshold, three ways to start up the braking regeneration system 100 include: 1) pull or push the rail car 110 to turn the axles 120 and generators 150, 2) use a Head-end Power (HEP) connection to provide electric power from the auxiliary engine generator in the locomotive, and 3) use a grid-based charger.

The first method is preferred and self managed. At start up, the generators 150 operate while the locomotive is pulling or pushing the rail car 110. The generators 150 place an extra drag on the locomotive but would only be active until the energy storage system 170 was at an operating level ready to accept the first deceleration energy capture. Normally, the first train deceleration would bring the energy storage system 170 to an operating capacity level, preparing it for the next acceleration event. Each deceleration event adds to the energy storage 170 state of charge (SOC) to achieve a full working level.

If desired, the other two methods are available for emergency backup. An HEP approach is similar to the current practice: start up the HEP and let it charge the system. A grid based charger could be used to connect the energy storage system 170 to a wayside power supply.

By way of example but not limitation of other types of passive rail cars, another advantage of implementation of the braking regeneration system 100 on a Comet V commuter rail car is an estimated fuel savings of $22,500 annually and in excess of $675,000 over the 30-year life of the rail car. This is based on the following assumptions: one 125,000 pound rail car generates 4.7 kWh of energy savings per deceleration act from an average speed of 70 mph; assuming that the rail car is in service 320 days out of the year and makes four revenue service trips per day (two AM peak and two PM peak) plus weekend service and holiday service, there are 25,600 energy reclamation opportunities (320 days at four passenger trips a day equates to 1280 trips a year of local service stopping 20 times); 25,600 opportunities at 4.7 kWh per stop per car results in a total recoupable energy level of 120,320 kWh, annual fuel savings would be approximately 9,000 gallons of diesel fuel based on an energy efficiency of 30%; at $2.50 per gallon for diesel fuel, fuel savings would total $22,500 annually and in excess of $675,000 over the 30-year life of the rail car. Since fuel costs generally rise over time, future savings are expected to be even greater than $22,500 annually. An additional benefit associated with the reduction in fuel use would be the reduction in exhaust emissions that the combustion of that fuel would have generated.

Also, by way of example but not limitation of other types of passive rail cars, additional advantages of implementation of the braking regeneration system 100 on a Comet V commuter car include benefits to the subsystems on the rail car. For example, because the recovered energy has been taken away from the generation of heat and wear in the brake system, the brake wear and corresponding maintenance for the brake system is reduced. The rail car decelerates by capturing energy on deceleration, while reducing the burden on the braking system. In hybrid-electric buses that use brake regeneration, brake maintenance intervals have been at least doubled. Therefore, a conservative estimate is that a 50% savings would be realized on the maintenance of the rail car brake system. This would double the current reline interval of the rail car 110 along with the subsequent labor and materials required to perform the reline.

The emergency power system would be the next area of savings. By way of example but not limitation of other types of passive rail cars, the Comet V rail car currently has a 74 volt DC emergency power system and battery charger on board each rail car. Other rail cars may operate their emergency power system at other voltages. This method of generating and storing energy for an emergency application period of up to 2 hours could be completely eliminated from the rail car and would then be incorporated into the energy storage system 170 and the auxiliary power inverter and conditioning module 180. The functions of the battery charger and the battery system are now assumed by the main energy storage 170 and can easily provide the emergency requirements. One clear benefit to this approach would be that the system 100 would be able to easily provide more than the two hours of required run time for the emergency backup at any point in time.

A more advanced potential for savings is the concept that the system 100 could actually be configured to provide adequate power so that each rail car 110 could provide energy for itself, thus, reducing head-end power (HEP) requirements. Under this concept, the braking regeneration energy storage system 100 could provide power for all hotel loads on the rail car 110 including HVAC, lighting and communications. Because the 50 kWh of battery energy storage supplies power to the rail car 110 through the inverter and power conditioning module 180, the HEP requirements are significantly reduced or eliminated. If it is desired to transfer power from the locomotive to the passenger rail car, it can be done through the wheels 130 by using the braking generator 150. This approach would reduce the electrical load and extend the life of the HEP system while saving HEP fuel and reducing diesel engine emissions.

An alternative embodiment of a braking regeneration system uses hydraulic components where a hydraulic motor/pump replaces the electric motor/generator 150; a hydraulic valve controller replaces the electric inverter switch controller 160; a hydraulic accumulator replaces the energy storage 170; and a hydraulic retarder replaces the braking resistors 190. The hydraulic retarder requires some form of liquid or air heat exchanger to dissipate energy. In its simplest form a hydraulic braking regeneration system is the hydraulic analog of the electric braking regeneration system and is a potentially lower cost alternative to an electric braking regeneration system to save fuel costs. Such systems have been built for medium duty hydraulic truck drive systems.

The amount of energy stored in an accumulator is a function of the accumulator pressure and the volume of fluid stored in the accumulator. The temperature of the system, the type of gas used to pre-charge the system, and the initial pressure of the pre-charge gas can impact the amount of energy stored at a given accumulator pressure. The equation to calculate the energy stored in an accumulator is:
E=(Pc*Vc−(P*Vc*((Pc/P)ˆ(1/k))))/(1−k)

Where: E is the energy stored in the accumulator.
Pc is the pre-charge pressure of the accumulator.
Vc is the volume of gas in the accumulator at pre-charge.
P is the current accumulator pressure. And
k is ratio of specific heats (Boltzmann constant) for the pre-charge gas.
   The value of k for a gas varies with pressure at high pressures;
   values of 1.3 to 1.8 may be used for typical gases and pressures.
      The pre-charge gas, pre-charge pressure, and volume of gas in the accumulator will not vary on a rail car over a route cycle. Thus, the State Of Charge (SOC) of a hydraulic accumulator is a function only of its pressure. Although the accumulator pressure will vary with charge gas temperature, the SOC can be determined with acceptable accuracy even if this term is ignored.

A hydraulic braking regeneration system is potentially less expensive than an electric braking regeneration system, but, depending on the practical limits of the size of the accumulator, may have limited energy storage. In concept, a hydraulic motor generator would replace the auxiliary power inverter 180 to power the auxiliary emergency and accessory electrical loads 210.

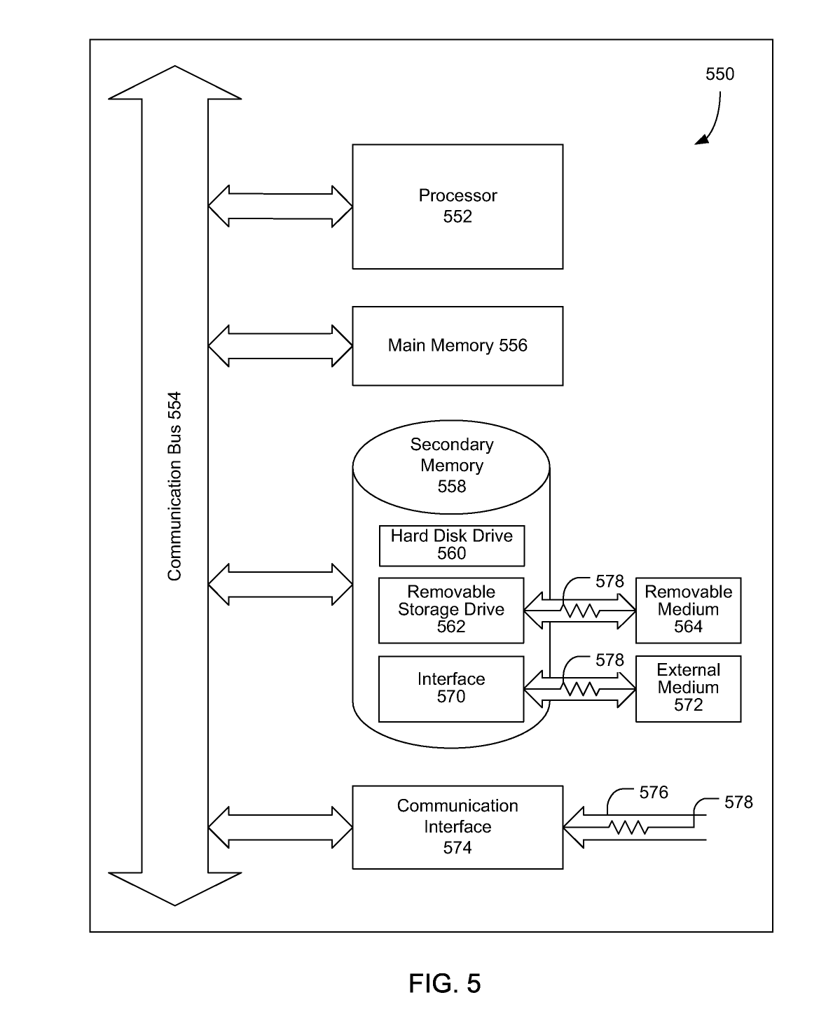

FIG. 5 is a block diagram illustrating an exemplary computer system 550 that may be used in connection with the various embodiments described herein. For example, the computer system 550 (or various components or combinations of components of the computer system 550) may be used in conjunction with the control computer 200 described above. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A braking regeneration and propulsion system for a passive rail car including an axle with wheels, the passive rail car primarily propelled by a separate driving locomotive, comprising:
a motor/generator operatively coupled to the axle;
an energy storage for storing captured energy and supplying energy; and
a control computer to assist deceleration of the passive rail car by causing the axle to drive the motor/generator via the gear box and supply energy to the energy storage system during deceleration, and, assist acceleration of the passive rail car by causing the motor/generator to draw energy from the energy storage system and drive the wheels via the gear box and axle during acceleration.

2. The braking regeneration and propulsion system of claim 1, wherein the rail car braking regeneration and propulsion system is axle-mounted.

3. The braking regeneration and propulsion system of claim 1, further including an inverter between the motor/generator and the energy storage.

4. The braking regeneration and propulsion system of claim 1, wherein the control computer is configured to prevent lurching of the passive rail car.

5. The braking regeneration and propulsion system of claim 1, wherein passive rail car is one of many passive rail cars primarily propelled by a separate driving locomotive, the braking regeneration and propulsion system is one of many braking regeneration and propulsion systems for the passive rail cars, the control computer is one of many control computers, and the control computers are configured to control the braking regeneration and propulsion systems to prevent lurching of the passive rail cars.

6. The braking regeneration and propulsion system of claim 1, wherein the passive rail car is at least one of a commuter cab car, a commuter trailer car, a flat car, a tank car, a box car, a bulk materials car, a container car, a specialty car, and a caboose.

7. The braking regeneration and propulsion system of claim 1, wherein the passive rail car includes more than one truck, each truck includes more than one axle with wheels and a separate braking regeneration and propulsion system for the truck, and each axle includes a separate gear box and a separate motor/generator.

8. The braking regeneration and propulsion system of claim 1, wherein the braking regeneration and propulsion system includes a braking resistor to dissipate excess energy generated by the braking regeneration and propulsion system.

9. The braking regeneration and propulsion system of claim 1, wherein the passive rail car includes multiple axles, and only one of the axles includes the braking regeneration and propulsion system.

10. The rail car braking regeneration and propulsion system of claim 1, wherein the motor/generator is a hydraulic motor/pump, and the energy storage is a hydraulic accumulator.

11. The system of claim 10, wherein the rail car braking regeneration and propulsion system is axle-mounted.

12. The braking regeneration and propulsion system of claim 10, further including a hydraulic controller between the motor/pump and the energy storage.

13. The braking regeneration and propulsion system of claim 10, wherein the control computer is configured to prevent lurching of the passive rail car.

14. The braking regeneration and propulsion system of claim 10, wherein passive rail car is one of many passive rail cars primarily propelled by a separate driving locomotive, the braking regeneration and propulsion system is one of many braking regeneration and propulsion systems for the passive rail cars, the control computer is one of many control computers, and the control computers are configured to control the braking regeneration and propulsion systems to prevent lurching of the passive rail cars.

15. The braking regeneration and propulsion system of claim 10, wherein the passive rail car is at least one of a commuter car, a flat car, a tank car, a box car, a bulk materials car, a container car, a specialty car, and a caboose.

16. The braking regeneration and propulsion system of claim 10, wherein the passive rail car includes more than one truck, each truck includes more than one axle with wheels and a separate braking regeneration and propulsion system for the truck, and each axle includes a separate gear box and a separate motor/generator.

17. The braking regeneration and propulsion system of claim 10, wherein the braking regeneration and propulsion system includes a hydraulic brake retarder to dissipate excess energy generated by the braking regeneration and propulsion system.

18. The braking regeneration and propulsion system of claim 10, wherein the passive rail car includes multiple axles, and only one of the axles includes the braking regeneration and propulsion system.

19. The system of claim 1, wherein the energy storage is one or more of a battery, ultracapacitor, and flywheel.

20. A method of using a braking regeneration and propulsion system with a passive rail car including an axle with wheels, the passive rail car primarily propelled by a separate driving rail car, comprising:
providing a braking regeneration and propulsion system including:
a motor/generator operatively coupled to the axle;
an energy storage for storing captured energy and supplying energy; and
a control computer to assist deceleration of the passive rail car by causing the axle to drive the motor/generator via the gear box and supply energy to the energy storage system, and, assist acceleration of the passive rail car by causing the motor/generator to draw energy from the energy storage system and drive the wheels via the gear box and axle;
assisting deceleration of the passive rail car by causing the axle to drive the motor/generator via the gear box and supply energy to the energy storage system;
assisting acceleration of the passive rail car by causing the motor/generator to draw energy from the energy storage system and drive the wheels via the gear box and axle.

21. The method of claim 20, wherein the braking regeneration and propulsion system is axle-mounted.

22. The method of claim 20, further including an inverter between the motor/generator and the energy storage.

23. The method of claim 20, wherein the control computer is configured to prevent lurching of the passive rail car.

24. The method of claim 20, wherein passive rail car is one of many passive rail cars primarily propelled by a separate driving locomotive, the braking regeneration and propulsion system is one of many braking regeneration and propulsion systems for the passive rail cars, the control computer is one of many control computers, and the control computers are configured to control the braking regeneration and propulsion systems to prevent lurching of the passive rail cars.

25. The method of claim 20, wherein the passive rail car is at least one of a commuter cab car, a commuter trailer car, a flat car, a tank car, a box car, a bulk materials car, a container car, a specialty car, and a caboose.

26. The method of claim 20, wherein the passive rail car includes more than one truck, each truck includes more than one axle with wheels and a separate braking regeneration and propulsion system for the truck, and each axle includes a separate gear box and a separate motor/generator.

27. The method of claim 20, wherein the braking regeneration and propulsion system includes a braking resistor to dissipate excess energy generated by the braking regeneration and propulsion system.

28. The method of claim 20, wherein the passive rail car includes multiple axles, and only one of the axles includes the braking regeneration and propulsion system.

29. The method of claim 20, wherein during acceleration the motor/generator operates for no more than 60 seconds at a power level no less than 282 kW before exhausting stored energy.

30. The method of claim 20, wherein during acceleration the motor/generator operates for more than 60 seconds at less than a 282 kW power level before exhausting stored energy.

31. The method of claim 20, wherein the motor/generator is a hydraulic motor/pump, and the energy storage is a hydraulic accumulator.

32. The method of claim 31, wherein the rail car braking regeneration and propulsion system is axle-mounted.

33. The method of claim 31, further including a hydraulic controller between the motor/pump and the energy storage.

34. The method of claim 31, wherein the control computer is configured to prevent lurching of the passive rail car.

35. The method of claim 31, wherein passive rail car is one of many passive rail cars primarily propelled by a separate driving locomotive, the braking regeneration and propulsion system is one of many braking regeneration and propulsion systems for the passive rail cars, the control computer is one of many control computers, and the control computers are configured to control the braking regeneration and propulsion systems to prevent lurching of the passive rail cars.

36. The method of claim 31, wherein the passive rail car is at least one of a commuter car, a flat car, a tank car, a box car, a bulk materials car, a container car, a specialty car, and a caboose.

37. The method of claim 31, wherein the passive rail car includes more than one truck, each truck includes more than one axle with wheels and a separate braking regeneration and propulsion system for the truck, and each axle includes a separate gear box and a separate motor/generator.

38. The method of claim 31, wherein the braking regeneration and propulsion system includes a hydraulic brake retarder to dissipate excess energy generated by the braking regeneration and propulsion system.

39. The method of claim 31, wherein the passive rail car includes multiple axles, and only one of the axles includes the braking regeneration and propulsion system.

40. The method of claim 31, wherein the energy storage is a hydraulic accumulator.

41. The system of claim 1, wherein the control computer transfers power from the driving locomotive by using the locomotive to turn the wheels/axles of the passive rail car.

42. The system of claim 10, wherein the control computer transfers power from the driving locomotive by using the locomotive to turn the wheels/axles of the passive rail car.

43. The method of claim 20, wherein the control computer transfers power from the driving locomotive by using the locomotive to turn the wheels/axles of the passive rail car.

44. The method of claim 31, wherein the control computer transfers power from the driving locomotive by using the locomotive to turn the wheels/axles of the passive rail car.

45. The braking regeneration and propulsion system of claim 1, wherein the motor/generator is integrated into one or more of the wheels.

46. The method of claim 20, wherein the motor/generator is integrated into one or more of the wheels.
